(19) United States
(12) Patent Application Publication
(10) Pub. No.: US 2004/0242168 A1
(43) Pub. Date: Dec. 2, 2004

(54) Module for transmitting and/or receiving radio data

(76) Inventors: Ralf Schultze, Berlin (DE); Heinrich Wilken, Berlin (DE)

Correspondence Address: MORRISON & FOERSTER LLP, 1650 TYSONS BOULEVARD, SUITE 300, MCLEAN, VA, 22102, US

(21) Appl. No.: 10/491,080

(22) PCT Filed: Sep. 10, 2002
(86) PCT No.: PCT/EP02/10141

(30) Foreign Application Priority Data
Sep. 28, 2001 (DE) 01123440.8

(51) Int. Cl. H04M 1/00

(52) U.S. Cl. 455/90.3; 455/575.7

(57) ABSTRACT

The invention relates to a module (10) for exchanging radio data, particularly mobile radio data, comprising: transmitting/receiving electronics for processing mobile radio signals to be transmitted and/or received; shielding means (12) for electromagnetically shielding the transmitting/receiving electronics, and; a transmitting/receiving antenna (22) for transmitting and/or receiving mobile radio signals. The shielding means (12) have at least one electrically conductive shielding cover (12) that encapsulates the transmitting/receiving electronics. The transmitting/receiving antenna (22) is placed in the vicinity of the at least one shielding cover (12) so that the latter serves, at least in sections, as a ground surface during the transmission and/or reception of mobile radio signals.

### CLAIM FOR PRIORITY

This application claims priority to International Application No. PCT/EP02/10141, which was published in the German language on Apr. 10, 2003, which claims the benefit of priority to German Application No. 01123440.8 which was filed in the German language on Sep. 28, 2001, the contents of which are hereby incorporated by reference.

### TECHNICAL FIELD OF THE INVENTION

The present invention relates to a module for interchanging radio data, in particular mobile radio data, in at least one frequency band.

### BACKGROUND OF THE INVENTION

A radio module such as this, which has functional transmitting/receiving electronics for transmitting and/or receiving radio data, is installed as an integral component in a communications terminal, such as a mobile radio telephone, and thus allows the mobile radio telephone to be manufactured in a simplified manner. However, in already known radio modules of this type, considerable effort is involved in making contact with the radio module and an external antenna, which is already installed or is to be installed retrospectively in the mobile radio terminal, during assembly of the communications terminal. This is because, during the process of making contact, it is necessary to ensure that the radio module is correctly coupled to the antenna, for example during insertion of the radio module into an open housing of the communications terminal. A further disadvantage of the already known solution is that, although the radio module makes a contribution to saving physical space by virtue of its integral construction, additional physical space must nevertheless be provided for the antenna, which is provided as a separate component, so that the external dimensions of the communications terminal become larger.

### SUMMARY OF THE INVENTION

The present invention provides a radio module of the type mentioned initially which, while being simple to install in a communications terminal, solves the problems mentioned above with regard to making contact with an external antenna and with regard to the physical space which is required for it.

In one embodiment of the invention, there is a module for interchanging radio data, in particular mobile radio data, in which the module according to the invention comprises:

transmitting/receiving electronics for processing mobile radio signals which are to be transmitted and/or to be received,

a shielding unit for electromagnetic shielding of the transmitting/receiving electronics, and

a transmitting/receiving antenna for transmitting and/or receiving mobile radio signals,

with the shielding unit having at least one electrically conductive shielding cover which encapsulates the transmitting/receiving electronics, and with the transmitting/receiving antenna being arranged in the region of the at least one shielding cover in such a way that, at least in places, this acts as a ground surface during transmission and/or reception of mobile radio signals.

As in the case of already known radio modules, the transmitting/receiving electronics in the radio module according to the invention are shielded against electromagnetic interference (EMC measure) within the shielding cover. However, the transmitting/receiving antenna is formed directly on the radio module, to be precise in such a manner that it can interact with the electrically conductive shielding cover in order to transmit or to receive the radio signals. In this case, at least in places, a part of the shielding cover acts as a ground surface. This may be achieved, for example, by arranging the transmitting/receiving antenna in the immediate vicinity of a surface area of the shielding cover, and hence using this as a ground surface. Thus, according to the invention, it is possible to produce a radio module which can be inserted as an integral assembly into a communications terminal during its assembly and in which, in addition to the transmitting/receiving electronics and shielding unit, this also comprises the transmitting/receiving antenna which is required for transmitting and receiving mobile radio signals. During use, the radio module according to the invention is already in a state in which it is ready to operate, that is there is no need to take special care when making contact with the radio module and a separately formed antenna. Furthermore, the direct fitting of the transmitting/receiving antenna to the module according to the invention allows space to be saved, since no further antennas in the form of separate components need be provided within the communications terminal. In this context, it should be mentioned that these antennas, which are in the form of separate components, generally require additional ground surfaces, for example additional ground surfaces provided on a printed circuit board, and this requires further physical space. This physical space can also be saved with the solution according to the invention.

Another embodiment of the invention allows the transmitting/receiving antenna to be in the form of a planar antenna. Designing the transmitting/receiving antenna as a planar antenna allows the radio module according to the invention to be designed such that it is more compact and more space-saving. In this case, in an embodiment of the invention, the transmitting/receiving antenna and the ground surface may lie in essentially parallel planes. It is thus possible for the shielding cover to be in the form of a cuboid hollow body, whose base surface forms the ground surface, and in which the planar antenna can be arranged parallel to the base surface.

To ensure reliable positioning of the transmitting/receiving antenna during operation of the module, one embodiment of the invention allows the transmitting/receiving antenna to be provided on an antenna mount composed of electrically non-conductive material, in particular of plastic. This makes its possible for the transmitting/receiving antenna to be formed, for example, by means of a thin metal layer which is applied to the antenna mount by electrochemical deposition or the like, and for this to be kept reliably at the desired distance from the round surface. The use of an antenna mount composed of plastic furthermore allows the module according to this embodiment of the invention to be produced in a cost-effective and robust manner.

In another aspect of the invention, the antenna mount may be fitted to the at least one shielding cover, preferably being placed on it. It is thus possible to design both the shielding cover and the antenna mount to have essentially the same shape and for them to be mechanically joined in a simple manner, such that the shielding cover is held, at least in places, in a recess which is provided in the antenna mount. This allows simple assembly of the module and, furthermore, reliable positioning of the transmitting/receiving antenna with respect to the shielding cover, which acts as a ground surface in places.

Another aspect of the invention allows the shielding cover and the antenna mount to be combined to form an integral unit. In this case, the radio module may be in the form of a compact unit that is simple to handle. This may be achieved, for example, by the antenna mount being fixed on the shielding cover by means of adhesive bonding or latching.

One exemplary embodiment of the invention allows the at least one shielding cover to be in the form of a hollow body which is open on one side and to be fitted, or to be capable of being fitted, via attachment sections, which are formed on its free edge, to a printed circuit board on which the transmitting/receiving electronics are mounted.

Furthermore, the at least one shielding cover and/or the antenna mount may be replaceable or interchangeable. Replaceability or interchangeability means that it is possible to use different antenna shapes with different emission characteristics which, for example, allow conversion of the radio module.

In order to reliably couple the transmitting/receiving electronics and transmitting/receiving antenna, which are arranged at a distance from one another, another embodiment of the invention allows the transmitting/receiving antenna to be connected to the transmitting/receiving electronics via a contact spring. In this context it shall be mentioned that the contact spring is actually fitted in the correct contact state during assembly of the radio module itself, so that no further attention need be paid to the contact spring during the final assembly of the communications terminal, that is during installation of the radio module according to the invention in an open housing, thus considerably simplifying the process of assembling the communications terminal.

The invention furthermore relates to a mobile radio terminal, preferably a mobile telephone, having a radio module of the type described above.

### BRIEF DESCRIPTION OF THE DRAWINGS

The invention will be described in the following text using the attached figures by way of example, in which:

FIG. 1 shows a side view of a radio module according to the invention.

FIG. 2 shows a plan view of the radio module according to the invention.

### DETAILED DESCRIPTION OF THE INVENTION

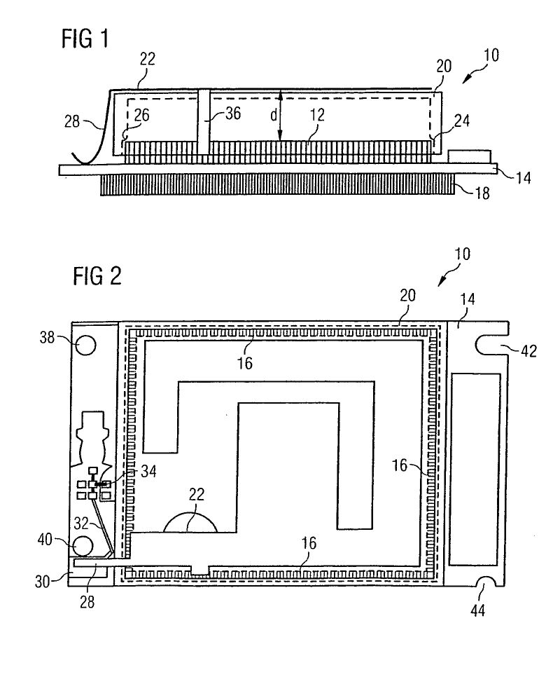

In FIGS. 1 and 2, a radio module according to the invention is annotated in general form by 10. This comprises transmitting/receiving electronics, which are accommodated in a shielding cover 12 and are installed on a printed circuit board 14, but which are not shown in any more detail. The shielding cover 12 is produced as a cuboid hollow body composed of electrically conductive material, for example of sheet metal, and its open lower face is placed over the transmitting/receiving electronics. A circumferential attachment lug 16, also referred to as feathering, is provided on the free edges of the shielding cover 12, by means of which the shielding cover 12 is attached to the printed circuit board 14, for example by adhesive bonding or soldering. A further shielding cover 18 is provided on the side of the printed circuit board 14 facing away from the shielding cover, and likewise shields the electronic components against electromagnetic interference.

An antenna mount 20 is fitted on the shielding cover 12, and a planar antenna 22 is fitted to its upper face, facing away from the printed circuit board 14. The antenna mount 20 is produced from an electrically non-conductive material, for example plastic material, and is likewise in the form of a cuboid hollow body, with its lower face, which faces the printed circuit board 14, being provided with an opening. At its entry, this opening has a stepped edge 24, which is designed and contoured such that it can be placed on the shielding cover, such that it holds the shielding cover. The stepped edge has a shoulder 26, which makes contact with that face of the shielding cover 12 which is on the top in FIG. 1. The shoulder 26 is arranged in the antenna mount 20 such that it ensures that there is a fixed predetermined distance d between the flat upper face of the shielding cover 12, which the antenna 22 uses as a ground surface, and the transmitting/receiving antenna 22, which is arranged essentially parallel to it. This distance d is also a governing factor for the emission characteristic of the antenna 22.

The antenna 22 is electrically conductively connected via a contact spring 28 to the printed circuit board, with the free end of the contact spring 28 pressing against an antenna connecting area 30, which is provided on the printed circuit board 14, in order to produce an electrical contact. The antenna connecting area 30 is coupled via a conductor track 32 to various circuit components 34, with the circuit electronics arranged in the shielding cover 12 or 18.

Furthermore, a conductor track 36 which connects the antenna 22 to the shielding cover 12 is provided for antenna matching. This conductor track 36 may be in the form of a metal web or contact spring.

The invention as shown in FIGS. 1 and 2 allows a space-saving, functional—in particular designed with a transmitting/receiving antenna—preconfigured radio module to be produced, which, in the illustrated manner, is in a ready-to-assemble state and can be inserted into an open housing of a communications terminal, for example a mobile radio terminal. In this case, the mobile radio standard which is used to operate the radio module is irrelevant and it can be operated, for example in accordance with the GSM standard, the UMTS standard or other widely used standards.

The radio module according to the invention offers the capability to be installed in a functional manner in a mobile radio terminal without having to ensure that, during assembly, it is coupled to an antenna which is already provided in the housing.

In this context, it should be mentioned that the reference symbols 38, 40, 42 and 44 denote various recesses for mounting the radio module 10 according to the invention in a housing.

Furthermore, in this context, it should be mentioned that the radio module according to the invention may also be designed and operated with types of antenna other than those shown in FIGS. 1 and 2.

1. A module interchanging radio data, in at least one frequency band, comprising:
transmitting/receiving electronics to process mobile radio signals which are to be transmitted and/or to be received;
a shielding unit to electromagnetically shield of the transmitting/receiving electronics; and
a transmitting/receiving antenna to transmit and/or receiving mobile radio signals,
with the shielding unit having at least one electrically conductive shielding cover which encapsulates the transmitting/receiving electronics, and with the transmitting/receiving antenna being arranged in a region of the at least one shielding cover such that, at least in part, it acts as a ground surface during transmission and/or reception of mobile radio signals, and with the transmitting/receiving antenna being connected to the transmitting/receiving electronics via a contact spring.

2. The module as claimed in claim 1,
wherein
the transmitting/receiving antenna is in the form of a planar antenna.

3. The module as claimed in claim 2,
wherein the transmitting/receiving antenna and the ground surface lie in essentially parallel planes.

4. The module as claimed in claim 2,
wherein the transmitting/receiving antenna is provided on an antenna mount composed of electrically non-conductive material.

5. The module as claimed in claim 4,
wherein he antenna mount is fitted to the at least one shielding cover/

6. The module as claimed in claim 5,
wherein the shielding cover and the antenna mount are combined to form an integral unit.

7. The module as claimed in claim 4, wherein at least one shielding cover is in the form of a hollow body which is open on one side, and is fitted, or can be fitted, via attachment sections, which are formed on a free edge, to a printed circuit board on which the transmitting/receiving electronics are mounted.

8. The module as claimed in claim 6, wherein the at least one shielding cover and/or the antenna mount are replaceable or interchangeable.

9. A mobile radio terminal, having a radio module, the module comprising:
transmitting/receiving electronics to process mobile radio signals which are to be transmitted and/or to be received;
a shielding unit to electromagnetically shield of the transmitting/receiving electronics; and
a transmitting/receiving antenna to transmit and/or receiving mobile radio signals, with the shielding unit having at least one electrically conductive shielding cover which encapsulates the transmitting/receiving electronics, and with the transmitting/receiving antenna being arranged in a region of the at least one shielding cover such that, at least in part, it acts as a ground surface during transmission and/or reception of mobile radio signals, and with the transmitting/receiving antenna being connected to the transmitting/receiving electronics via a contact spring.
